(19) United States
(12) Patent Application Publication
(10) Pub. No.: US 2016/0239623 A1
(43) Pub. Date: Aug. 18, 2016

(54) MEDICAL DEVICE COMPRISING MULTI-FUNCTIONAL SOCKET

(71) Applicant: BBB INC., Seongnam-si (KR)

(72) Inventors: Jaekyu CHOI, Seongnam-si (KR); Jisoon LIM, Seongnam-si (KR)

(21) Appl. No.: 14/850,566

(22) Filed: Sep. 10, 2015

(30) Foreign Application Priority Data
Feb. 16, 2015 (KR) 10-2015-0023299

(51) Int. Cl. G06F 19/00

(52) U.S. Cl. CPC G06F 19/3406

(57) ABSTRACT

The present disclosure relates to a medical device comprising a multi-functional socket, comprising, a socket capable of being connected with a health information measuring device or a bio sensor module, the type of which are different from each other; and a control portion receiving an identification information from a health information measuring device or a bio sensor module, via the socket, when the socket is connected with the health information measuring device or the bio sensor module, recognizing a type of the health information measuring device or the bio sensor module, and operating an exclusive program for the recognized health information measuring device or the bio sensor module, wherein a type of an exclusive program operated by the control portion differs depending on a type of the health information measuring device or the bio sensor module.

### TECHNICAL FIELD

The present invention relates to a medical device comprising a multi-functional socket, and more particularly, to a medical device comprising a multi-functional socket which can be connected with many different types of a health information measuring device or a bio sensor module.

### CROSS-REFERENCE TO RELATED APPLICATION

This application claims the priority of the Korean Patent Application No. 10-2015-0023299, filed on Feb. 16, 2015 in the Korean Intellectual Property Office (KIPO), and all the benefits accruing therefrom under 35 U.S.C. §119, the contents of which in their entirety are herein incorporated by reference.

### BACKGROUND ART

As average life expectancy increases, the interest in health is rapidly growing. In turn, the healthcare industry comes into the spotlight. Currently, a variety of devices providing healthcare service has already been developed, or is under development. And the existing devices are also being reformed in more user-friendly way.

A blood analysis apparatus is the best example of the health care device; since the analysis on human blood provides useful information on the human's health, the research and development for analyzing human blood has been continuously supported. The blood analysis apparatus currently used has a user interface enabling to display the result from a measurement of blood on a display of the device, and to print the result as necessary.

### DISCLOSURE OF INVENTION

### Technical Problem

However, the conventional healthcare devices, including the above-mentioned blood analysis apparatus, particularly a health information measuring device designed on the basis of a firmware, includes just a minimum display and interface, or designed on the basis of an imbedded operating system, operates only an application exclusive for the relevant device. That is, the conventional health information measuring device has a limitation in that it operates to perform only one function; for example, the above-mentioned blood analysis apparatus has a function limited to measuring and analyzing either blood sugar or glycated hemoglobin.

This required a user should have many different health care measuring devices in order to get comprehensive health information, causing a burden of expenses. Therefore, the technical development of a single device measuring many different types of health information is urgently needed in order for implementing comprehensive analysis of the user's health condition.

Therefore, an object of the present invention devised to solve the conventional problem is to provide a medical device comprising a multi-functional socket which can be connected with many different types of a health information measuring device or a bio sensor module.

It is a further object of the present invention to provide a medical device comprising a multi-functional socket capable of automatically recognizing the type of a health information measuring device or a bio sensor module connected therewith.

It is yet another object of the present invention to provide a medical device comprising a multi-functional socket capable of browsing online for an exclusive program for the health information measuring device or the bio sensor module connected therewith.

The objects of the present invention are not limited to the above-mentioned, and the other objects not mentioned herein will be readily apparent to those skilled in the art from the description to follow.

### Effects of The Invention

The various effects discussed below can be achieved according to the present invention as previously mentioned, but the effects are not limited to those which follow.

First, since different types of a health information measuring device or a bio sensor module can be connected with a socket, according to the present invention, a single medical device can provide various health information on a user depending on the type of the health information measuring device or the bio sensor module connected therewith, without using a plurality of separate medical devices.

Second, since the type of the health information measuring device or the bio sensor module connected with the socket can be automatically recognized, according to the present invention, it can be possible to search for and operate the exclusive program for the connected health information measuring device or the bio sensor module.

Third, since it is possible to browse online for the exclusive program for the relevant device, which is not saved yet in the medical device, many different types of the health information measuring device or the bio sensor module can be utilized.

### BRIEF DESCRIPTION OF DRAWINGS

FIG. 1 is a diagram illustrating an outline configuration of a medical device comprising a multi-functional socket according to a first exemplary embodiment of the present invention.

FIG. 2 is a diagram illustrating an outline configuration of a medical system including the medical device of FIG. 1.

FIG. 3 is a diagram illustrating an operation of the medical device of FIG. 1.

FIG. 4 is a diagram illustrating an outline configuration of a medical device comprising a multi-functional socket according to a second exemplary embodiment of the present invention.

FIG. 5 is a diagram illustrating an outline configuration of a medical device comprising a multi-functional socket according to a third exemplary embodiment of the present invention.

FIG. 6 is a diagram illustrating an outline configuration of a medical device comprising a multi-functional socket according to a forth exemplary embodiment of the present invention.

FIG. 7 is a diagram illustrating an outline configuration of a medical device comprising a multi-functional socket according to a fifth exemplary embodiment of the present invention.

### DETAILED DESCRIPTION OF THE INVENTION

A desirable exemplary embodiment of the present invention will be described in detail hereinafter in reference with the accompanied drawings. The advantage and characteristic, and a method to achieve them will be obvious upon detailed description of the exemplary embodiments as well as accompanied drawings which follow. However, the present invention is not limited to the exemplary embodiments set forth herein, but can be embodied in many different forms. The exemplary embodiments are provided only to render the present disclosure complete and the scope of the present invention comprehensible to those having ordinary skill in the art. The present invention is only to be defined by the claims. A same reference mark used refers to a same element throughout the description.

Without separate definitions, all terms (including technical and scientific terms) used in the present description may be used for the meanings commonly understandable to those having ordinary skill in the art. In addition, the terms generally used and having definitions in dictionary, unless otherwise defined obviously in particular, should not be ideally or exaggeratedly interpreted.

The terms used in the present description are to explain the exemplary embodiments, not to limit the present invention thereto. In the present description, a singular form of word also includes a plural form thereof unless otherwise noted. The term “comprises” and/or “comprising” is not excluding the meaning that one or more elements other than the said element may exist or be added.

With reference to the drawings, a medical device comprising a multi-functional socket will be described hereinafter according to the exemplary embodiments of the present invention.

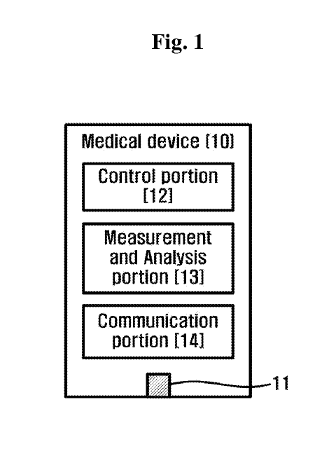

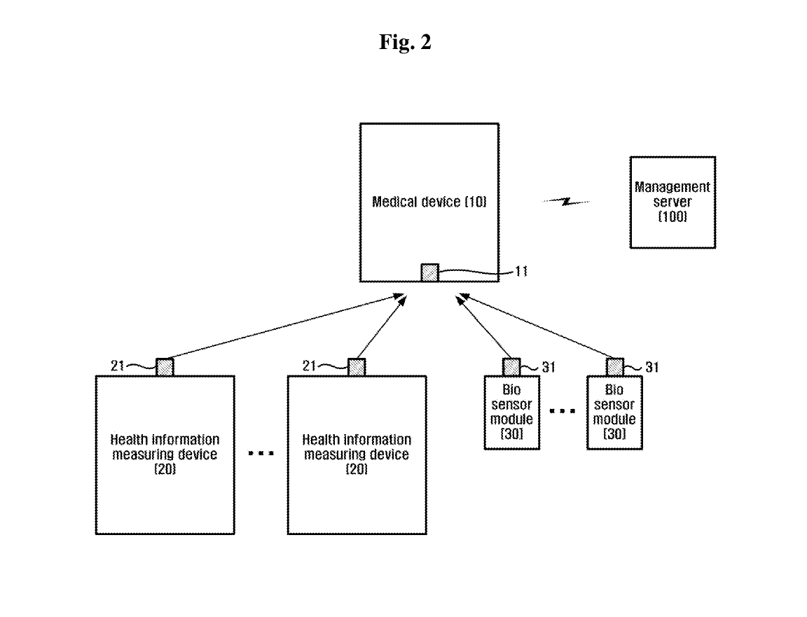

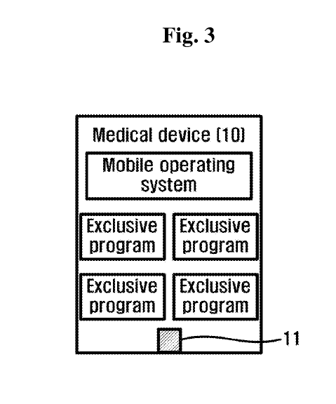

With reference to FIG. 1 through FIG. 3, a medical device (10) comprising a multi-functional socket (11) according to a first exemplary embodiment of the present invention will be described hereinafter. FIG. 1 shows an outline configuration of the medical device (10) comprising a multi-functional socket (11) according to the first exemplary embodiment of the present invention. FIG. 2 shows an outline configuration of a medical system including the medical device (10) of FIG. 1, and FIG. 3 illustrates an operation of the medical device (10) of FIG. 1.

First of all, with reference to FIG. 1 and FIG. 2, a function of the medical device (10) according to the first exemplary embodiment of the present invention will be briefly described. By using the medical device (10) according to the first exemplary embodiment of the present invention, many different types of the health information measuring device can be controlled, and a sensing result provided by many different types of the bio sensor module can be measured and analyzed with a single medical device (10). In addition, the health information measured and analyzed by a health information measuring device (20), or that of the sensing result provided by a bio sensor module (30) connected with the medical device (10), can be transmitted from the medical device (10) to a management server (100). Such method helps efficiently collecting the health information on a user.

At this, the health information measuring device (20), not subordinated to the medical device (10), operates independently to measure and analyze the user's health information. The example of such device may include, but is not limited to, a manometer, a body composition measuring instrument, a thermometer, an electrocardiogram, and an electroencephalogram. And the health information measuring device (20) includes a connection terminal (21), thereby being connected with the socket (11) of the medical device (10).

The bio sensor module (30) is used for measuring a user's biometric data; for example, it can be modularized in the form of strip, but the form is not limited to the strip. When the user's body sample is provided, the bio sensor module (30) can implement a sensing to measure the biometric data generated from the body sample. And the result of sensing can be provided to the medical device (10) via the socket (11). For example, even though the bio sensor module (30) specifically capable of sensing blood sugar or cholesterol can be used, the bio sensor module (30) capable of sensing many different biometric data, not just a specific data, can be also used. In addition, the bio sensor module (30) includes a connection terminal (31), thereby being connected to the socket (11) of the medical device (10).

Meanwhile, the identification information on the health information measuring device (20) or the bio sensor module (30) can be recorded in the form of physical pattern or electronic data in the relevant health information measuring device (20) or the bio sensor module (30). At this, the identification information, as a kind of ID (identification), may include, but is not limited to, the information on the type of the relevant health information measuring device (20) or the bio sensor module (30), and the information on the exclusive program for the relevant health information measuring device (20) or the bio sensor module (30).

An electrode pattern or mechanical pattern of ribs may be the examples of physical pattern to be formed in the health information measuring device (20) or the bio sensor module (30). For example, those patterns can be formed in their connection terminals (21, 31), but the location where the pattern is formed is not limited to the connection terminals (21, 31). Such physical pattern information can be recognized by the socket (11) of the medical device (10).

The management server (100) saves all kinds of health information of the user transmitted from the medical device (10). For example, it functions as database, but its function is not limited thereto. According to the exemplary embodiments of the present invention, the type of the health information measurable and analyzable in the medical device (10) is not limited. On the contrary, the type of the health information measurable and analyzable can be rather extended according to the type of the health information measuring device (20) and/or the bio sensor module (30) connected with the socket, providing a variety of health information on the user to the management server (100).

The detailed configuration of the medical device (10) will be described hereinafter. As shown in FIG. 1, the medical device (10) may include a socket (11), a control portion (12), a measurement and analysis portion (13), and a communication portion (14). However, in some exemplary embodiments, the number of components used to form the medical device (10) may be more, or less than the number of components shown in FIG. 1.

The socket (11) is connected with each of the different types of the health information measuring device (20) or the bio sensor module (30). That is, many different types of the health information measuring device (20) or the bio sensor module (30) including the standard connection terminal (21, 31), connectable or compatible with the socket (11) of the medical device (10), can be recognized by being connected with the socket (11) of the medical device (10). Accordingly, the socket (11) of the medical device (10) may be a multi-functional socket capable of recognizing many different types of device or module. The number of socket (11) included in the medical device (10) of the present invention may not be limited to one, but may be more than one, as necessary.

The control portion (12) controls the medical device (10) in general. In particular, when the socket (11) is connected with the health information measuring device (20) or the bio sensor module (30), the control portion (12) receives the identification information from the health information measuring device (20) or the bio sensor module (30) via the socket (11), and recognizes the type of the health information measuring device (20) or the bio sensor module (30), and operates the exclusive program for the recognized health information measuring device (20) or the bio sensor module (30). In other words, since the type of the exclusive program to be operated by the control portion (12) differs depending on the type of the health information measuring device (20) or the bio sensor module (30) connected with the socket (11), the exclusive program corresponding to the type of the connected health information measuring device (20) or the bio sensor module (30) can be operated.

As shown in FIG. 3, since various kinds of the exclusive program controlling the relevant health information measuring device (20) or bio sensor module (30) can be installed in the medical device (10), the medical device (10) can work normally despite many different types of the health information measuring device (20) or the bio sensor module (30) are connected thereto via the socket (11). Moreover, since the medical device (10) can make a call and operate the relevant exclusive program by using the identification information on the health information measuring device (20) or the bio sensor module (30) connected with the socket (11), the user can easily operate the relevant health information measuring device (20) or the bio sensor module (30) only by connecting them to the medical device (10) without a separate set-up.

At this, as previously described, the identification information may be recorded in the health information measuring device (20) or the bio sensor module (30) in the form of physical pattern or electronic data, and can be entered by the health information measuring device (20) or the bio sensor module (30) into the medical device (10) via the socket (11). In particular, in the form of physical pattern, the identification information can be identified by the relationship with the socket (11), and in the form of electronic data, the information can be transmitted via the socket (11). The identification information of the health information measuring device (20) or the bio sensor module (30), connected as such, is provided to the medical device (10), enabling easy control of the medical device (10), as previously described.

Meanwhile, in the case where the exclusive program for the health information measuring device (20) or the bio sensor module (30) connected with the socket (11) is not installed in the medical device (10), the control portion (12) can browse online for the program though a communication portion (14) which will be described hereinafter. And the control portion (12) may automatically download and install the found program in the medical device (10), or let the user download and install the program.

According to the first exemplary embodiment of the present invention, the medical device (10) secures expandability on the usage of an external health information measuring device (20) or bio sensor module (30) as it is possible to browse online and download the necessary exclusive program for the health information measuring device (20) or the bio sensor module (30).

Besides, the medical device (10) according to the first exemplary embodiment of the present invention can have a mobile operating system; the control portion (12), and the exclusive program as well, may operate on the basis of the mobile operating system.

The measurement and analysis portion (13) measures and analyzes the health information by receiving the sensing result from the recognized bio sensor module (30). Measuring and analyzing health information by using the sensing result can be implemented in software, and also implemented in hardware as necessary; thus, the measurement and analysis portion (13) may include at least one of: the software and the hardware configurations.

The communication portion (14) is capable of external communication. In particular, the medical device (10) can communicate with the management server (100) by using the communication portion (14), and browse online for the necessary exclusive program. For example, the communication portion (14) may communicate on the basis of various standards such as 3G, LTE (Long Term Evolution), Wi-Fi, and Bluetooth. Not limited to the above-mentioned, it may further communicate by using various wired and wireless methods of communication. Furthermore, the medical device (10) according to the first exemplary embodiment of the present invention has a mobile operating system, providing the optimal condition for operating the communication portion (14) capable of wireless communication.

On the basis of the configuration of the above-described medical device (10), the operation of the medical device (10) according to the first exemplary embodiment of the present invention will be described hereinafter.

As previously described, when the health information measuring device (20) or the bio sensor module (30) is connected with the socket (11) of the medical device (10), the control portion (12) receives the identification information from the health information measuring device (20) or the bio sensor module (30) via the socket (11), and recognizes the type of the health information measuring device (20) or the bio sensor module (30), and operates the exclusive program for the recognized health information measuring device (20) or bio sensor module (30).

Subsequently, the control portion (12) can control the connected health information measuring device (20) or the bio sensor module (30) on the basis of the exclusive program for it.

For example, when connected with the health information measuring device (20), the control portion (12) can receive the health information previously measured and analyzed by the health information measuring device (20), and transmit the received health information to the management server (100) by using the communication portion (14). In this way, by using the medical device (10) according to the first exemplary embodiment of the present invention, the health information provided by the health information measuring device (20), which is unable to carry out wireless communication autonomously, can be easily transmitted to the management server (100).

In addition, when connected with the health information measuring device (20), the control portion (12) controls the health information measuring device (20) so that it continues to implement a measurement and analysis. Therefore, the medical device (10) can operate as a measuring device performing the function of the health information measuring device (20) connected therewith.

Meanwhile, when the bio sensor module (30) is connected, the control portion (12) controls the measurement and analysis portion (13) so that it performs measurement and analysis on the basis of the method determined according to the exclusive program operated by the control portion (12). And as necessary, the health information drawn by the measurement and analysis portion (13) can be transmitted to the management server (100) through the communication portion (14). In this way, the sensing result from the bio sensor module (30) can be measured and analyzed by the measurement and analysis portion (13) in an appropriate manner.

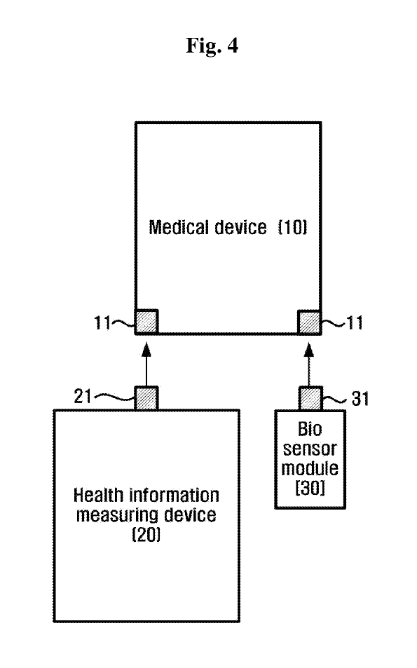

With reference to FIG. 4, a medical device (10) comprising a multi-functional socket (11) according to a second exemplary embodiment of the present invention will be described hereinafter. The description will be mainly focused on the differences from the medical device (10) according to the first exemplary embodiment of the present invention. FIG. 4 shows an outline configuration of a medical device (10) comprising a multi-functional socket (11) according to the second exemplary embodiment of the present invention.

As shown in FIG. 4, the medical device (10) according to the second exemplary embodiment of the present invention may include a plurality of the sockets (11). For example, one of the sockets (11) may be connected with the health information measuring device (20), and the other one may be connected with the bio sensor module (30). Therefore, the control portion (12) controls providing the sensing result which is transmitted from the bio sensor module (30) to the health information measuring device (20) so that it is measured and analyzed.

Accordingly, the medical device (10) according to the second exemplary embodiment of the present invention enables to utilize a combination of the connected health information measuring device (20) and bio sensor module (30)

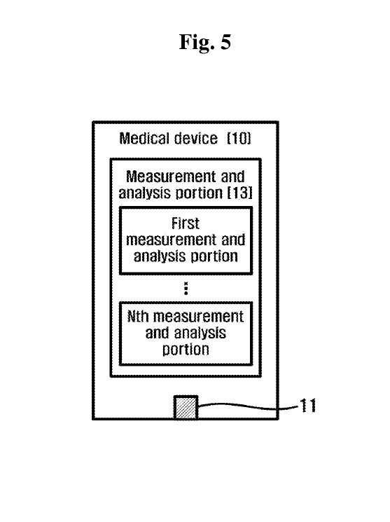

With reference to FIG. 5, a medical device (10) comprising a multi-functional socket (11) according to a third exemplary embodiment of the present invention will be described hereinafter. The description will be mainly focused on the differences from the medical device (10) according to the first exemplary embodiment of the present invention. FIG. 5 shows an outline configuration of the medical device (10) comprising a multi-functional socket (11) according to the third exemplary embodiment of the present invention.

As shown in FIG. 5, the measurement and analysis portion (13) of the medical device (10) according to the third exemplary embodiment of the present invention may include a plurality of measuring and analyzing modules, and each of the measuring and analyzing modules may have a different method or target for implementing a measurement and analysis. Therefore, the control portion (12) selects the proper measuring and analyzing module from the measurement and analysis portion (13) on the basis of the identification information, and controls the selected measuring and analyzing module so that it receives the sensing result from the recognized bio sensor module (30) to measure and analyze the health information.

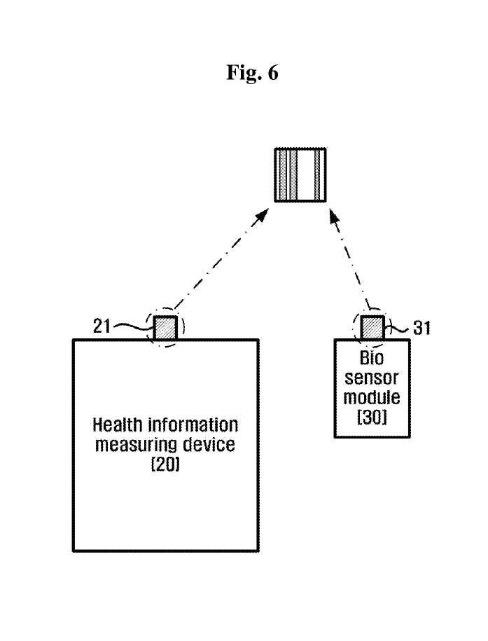

With reference to FIG. 6, a medical device (10) comprising a multi-functional socket (11) according to a forth exemplary embodiment of the present invention will be described hereinafter. The description will be mainly focused on the differences from the medical device (10) according to the first exemplary embodiment of the present invention. FIG. 6 shows an outline configuration of the medical device (10) according to the forth exemplary embodiment of the present invention.

The medical device (10) according to the forth exemplary embodiment of the present invention can receive, via the socket (11), the identification information on the health information measuring device (20) or the bio sensor module (30) from the health information measuring device (20) or the bio sensor module (30), of which identification information is recorded in the form of electrode pattern as a physical pattern.

Particularly, as shown in FIG. 6, the electrode pattern may be formed on the connection terminal (21, 31) in order to correspond to the identification information of the health information measuring device (20) or the bio sensor module (30). For example, in the case where each of the health information measuring device (20) or the bio sensor module (30) has its own feature, the electrode pattern included therein may be different from each other.

Meanwhile, the electrode can be formed also on the socket (11) of the medical device (10). Therefore, in the case where the connection terminal (21, 31) of the health information measuring device (20) or the bio sensor module (30) is connected with the socket (11) of the medical device (10), the point at which the electrode of the socket (11) is contacted with the connection terminal (21, 31) may be varied according to the electrode pattern which is formed on the connection terminal (21, 31). In other words, of the connection terminals (21, 31), the point of contact may be formed on the electrode located on a specific spot of the socket (11) corresponding to the part where the electrode pattern is formed, but is not formed on the electrode located on a specific spot of the socket (11) corresponding to the part where the electrode pattern is not formed.

According to the exemplary embodiment of the present invention, due to such difference, the recognition of the electrode of the socket (11) may be differentiated; thus, the medical device (10) can recognize the identification information on the health information measuring device (20) or the bio sensor module (30).

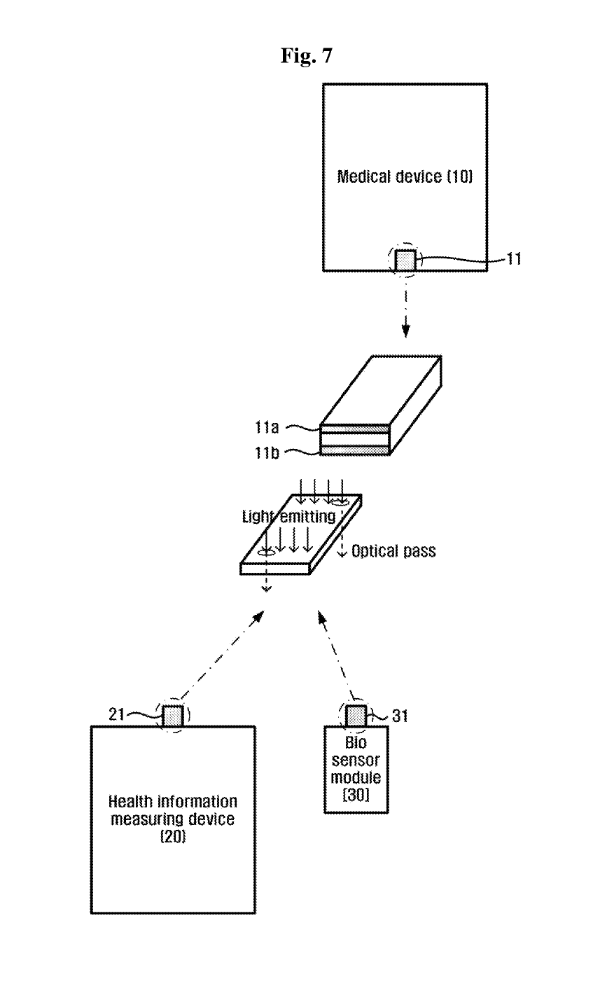

With reference to FIG. 7, a medical device (10) comprising a multi-functional socket (11) according to a fifth exemplary embodiment of the present invention will be described hereinafter. The description will be mainly focused on the differences from the medical device (10) according to the exemplary embodiment of the present invention. FIG. 7 shows an outline configuration of the medical device (10) comprising a multi-functional socket (11) according to the fifth exemplary embodiment of the present invention.

The medical device (10), according to the fifth exemplary embodiment of the present invention, can receive the identification information on the health information measuring device (20) or the bio sensor module (30), via the socket (11), from the health information measuring device (20) or the bio sensor module (30) of which the health information is recorded in the form of a hole as a physical pattern.

Particularly, as shown in FIG. 7, a patterning with a hole can be formed on the connection terminal (21,31) in order for corresponding to the identification information of the health information measuring device (20) or the bio sensor module (30). For example, in the case where the health information measuring device (20) or the bio sensor module (30) has its own feature, the patterning with a hole included in the health information measuring device (20) or the bio sensor module (30) may be different from each other.

Meanwhile, the socket (11) of the medical device (10) may include a light emitting portion (11a) and a light receiving portion (11b). Thus, in the case where the connection terminal (21, 31) of the health information measuring device (20) or the bio sensor module (30) is connected with the socket (11) of the medical device (10), the light emitting portion (11a) of the socket can generate and emit light. And, the light receiving portion (11b), faced each other with the light emitting portion (11a) across the connection terminal (21, 31) inserted in the socket (11), receives the light through the hole at the location where the patterning including the hole is formed, and may not receive the light at the location where the patterning including the hole is not formed.

Since the recognition of the electrode of the socket (11) may be differentiated due to such difference, the medical device (10) according to the exemplary embodiment can recognize the identification information on the health information measuring device (20) or the bio sensor module (30).

A medical device (10) comprising a multi-functional socket (11) according to a sixth exemplary embodiment of the present invention will be described hereinafter. The description will be mainly focused on the differences from the medical device (10) according to the first exemplary embodiment of the present invention.

The medical device (10) according to the sixth exemplary embodiment of the present invention can receive the identification information on the health information measuring device (20) or the bio sensor module (30), via the socket (11), from the health information measuring device (20) or the bio sensor module (30) wherein the identification information is recorded in the form of optically identifiable pattern such as barcode or QR (Quick Response) code as a physical pattern

For example, the optically identifiable pattern, corresponding to the identification information of the health information measuring device (20) or the bio sensor module (30), can be printed on the connection terminal (21, 31), but the location on which the optically identifiable pattern is printed is not limited to the connection terminal (21, 31). For example, in the case where the health information measuring device (20) or the bio sensor module (30) has its own feature, the optically identifiable pattern with a hole included in the health information measuring device (20) or the bio sensor module (30) may be different from each other.

Meanwhile, the socket (11) of the medical device (10) may include a scanner capable of scanning the optically identifiable pattern. Therefore, in the case where the connection terminal (21, 31) of the health information measuring device (20) or the bio sensor module (30) is connected with the socket (11) of the medical device (10), the optically identifiable pattern thereof can be recognized by using the scanner of the socket (11).

A medical device (10) comprising a multi-functional socket (11) according to a seventh exemplary embodiment of the present invention will be described hereinafter. The description will be mainly focused on the differences from the medical device (10) according to the first exemplary embodiment of the present invention.

The medical device (10) according to the seventh exemplary embodiment of the present invention can receive the identification information of the health information measuring device (20) or the bio sensor module (30), via the socket (11), from the health information measuring device (20) or the bio sensor module (30) in which the identification information is recorded in the form of ribs as a physical pattern.

For example, the ribs, corresponding to each of the identification information on the health information measuring device (20) or the bio sensor module (30), can be formed on the connection terminal (21, 31). In the case where the health information measuring device (20) or the bio sensor module (30) has its own feature, the ribs included in each of the health information measuring device (20) or the bio sensor module (30) may be differentiated.

Meanwhile, the switch array can be formed on the socket (11) of the medical device (10). Therefore, when the connection terminal (21, 31) of the health information measuring device (20) or the bio sensor module (30) is connected with the socket (11) of the medical device (10), the switch array of the socket (11) is closed by the protruding part, and is opened for the recession part of the ribs.

According to the exemplary embodiment, the recognition of the electrode of the socket (11) may be varied due to such difference; therefore, the medical device (10) can recognize the identification information on the health information measuring device (20) or the bio sensor module (30).

A medical device (10) comprising a multi-functional socket (11) according to an eighth exemplary embodiment of the present invention will be described hereinafter. The description will be mainly focused on the differences from the medical device (10) according to the first exemplary embodiment of the present invention.

The medical device (10) according to the eighth exemplary embodiment of the present invention can receive the identification information on the health information measuring device (20) or the bio sensor module (30), via the socket (11), from the health information measuring device (20) or the bio sensor module (30) in which the identification information is recorded by using a memory chip as a form of electronic data.

Particularly, the health information measuring device (20) or the bio sensor module (30) may include the memory chip in which the identification information is recorded, and transmit the identification information through the connection terminal (21, 31) to the socket (11) by wire; for example, the method of wired transmission includes, but is not limited to, a byte-serial transmission. Accordingly, the medical device (10) receives the identification information on the health information measuring device (20) or the bio sensor module (30) via the socket (11).

A medical device (10) comprising a multi-functional socket (11) according to a ninth exemplary embodiment of the present invention will be described hereinafter. The description will be mainly focused on the differences from the medical device (10) according to the eighth exemplary embodiment of the present invention.

The medical device (10) according to the ninth exemplary embodiment of the present invention is capable of communicating wirelessly with the health information measuring device (20) or the bio sensor module (30). For example, the medical device (10), the health information measuring device (20), and the bio sensor module (30) may include a radio-frequency identification chip such as RFID (Radio-Frequency Identification) or NFC (Near Field Communication).

Therefore, when the connection terminal (21, 31) of the health information measuring device (20) or the bio sensor module (30) is combined with the socket (11) of the medical device (10), the health information measuring device (20) or the bio sensor module (30) transmits a specific group of bytes in the radio-frequency identification chip to the medical device (10), and by receiving such information, the medical device (10) can receive the identification information on the health information measuring device (20) or the bio sensor module (30).

It is clearly understandable for those having ordinary skill in the art the present invention can be embodied in various forms, other than the exemplary embodiments set forth herein, without changes in its technical idea or essential characteristic. The exemplary embodiments described herein are only for the purpose of exemplifying the present invention in all aspects, not of limiting the scope of the present invention.

1. A medical device comprising a multi-functional socket, comprising a socket capable of being connected with a health information measuring device or a bio sensor module, the type of which are different from each other; and
a control portion receiving an identification information from a health information measuring device or a bio sensor module, via the socket,
when the socket is connected with the health information measuring device or the bio sensor module, recognizing a type of the health information measuring device or the bio sensor module, and operating an exclusive program for the recognized health information measuring device or the bio sensor module,
wherein a type of an exclusive program operated by the control portion differs depending on a type of the health information measuring device or the bio sensor module.

2. The medical device of claim 1,
wherein the identification information is recorded in the health information measuring device or the bio sensor module in the form of a physical pattern or of an electronic datum, and is entered into the medical device, via the socket, from the health information measuring device or the bio sensor module.

3. The medical device of claim 1, further comprising
a communication portion capable of external communication,
wherein the control portion browses online for an exclusive program,
through the communication portion, in the case where the exclusive program for the recognized health information measuring device or the bio sensor module is not installed.

4. The medical device of claim 1, further comprising
a measurement and analysis portion measuring and analyzing a health information by receiving a sensing result from the recognized bio sensor module,
wherein the control portion, on the basis of a method determined according to an exclusive program operated thereby, controls the measurement and analysis portion so that it implements a measurement and analysis.

5. The medical device of claim 1,
having a mobile operating system on the basis of which the exclusive program is operated.
